(19) United States
(12) Patent Application Publication
(10) Pub. No.: US 2013/0147245 A1
(43) Pub. Date: Jun. 13, 2013

(54) Padded Armrest

(71) Applicants: Javier Torres, Fairless Hills, PA (US); Gaylord Craig, III, South Plainfield, NJ (US)

(72) Inventors: Javier Torres, Fairless Hills, PA (US); Gaylord Craig, III, South Plainfield, NJ (US)

(21) Appl. No.: 13/688,302

(22) Filed: Nov. 29, 2012

Related U.S. Application Data
(60) Provisional application No. 61/569,952, filed on Dec. 13, 2011.

(51) Int. Cl. B60N 2/58

(52) U.S. Cl. CPC B60N 2/58
USPC 297/227

(57) ABSTRACT

A cushion device is disclosed for covering and protecting the center console and/or armrest in a vehicle. The cushion device comprises an outer covering and a cushion insert. The outer covering comprises an interior hollow cavity with an opening at either end. The cushion insert is disposed interior to the outer covering within the hollow cavity. The cushion device is then removably secured to a vehicle seat armrest or console lid, or other suitable vehicle part. The cushion device is typically secured via a looped component (or sleeve) which is secured to the bottom portion of the outer covering. The outer covering can further comprise a securing component to securely close the opening at either end, and to securely retain the cushion insert within the outer covering.

### CROSS-REFERENCE

This application claims priority from Provisional Patent Application Ser. No. 61/569,952 filed Dec. 13, 2011.

### BACKGROUND

Many drivers and passengers rest their arms on top of the center console or armrest of a vehicle. However, this surface is typically made from hard plastic, which doesn't provide much comfort. Further, it may be covered in material, making it slightly more comfortable, but the material still may not add a lot of extra cushion or support. Additionally, if drivers and passengers are constantly placing their arms on the center console or armrest, the top surface can fade, rip, tear and/or become discolored. Also, the lid of the center console may break or otherwise fail from excessive pressure being applied thereto over an extended period of time. An effective solution to prevent these problems is necessary.

There is a need for an improved armrest that can provide drivers and passengers with a convenient and comfortable place to rest their arm while driving or riding in a motor vehicle. The present invention resembles a sleeve-like device that can be removably slipped onto the top surface or lid of an existing center console or armrest in a vehicle. The armrest device can be padded and covered with variously designed fabrics. Along with providing a padded resting area for users, the armrest device can also protect the top surface or lid of the console or armrest and prevent it from fading and/or damage. Furthermore, if the improved armrest device becomes damaged over time from repeated use, the armrest device can be easily replaced. All vehicle owners can appreciate the convenience and practicality afforded by this product.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a cushion device used to cover and protect the center console and/or armrest in a vehicle. The cushion device comprises an outer covering and a cushion insert. The outer covering comprises an interior hollow cavity with an opening at either or both ends. The cushion insert is disposed interior to the outer covering within the hollow cavity. The cushion device is then removably secured to a vehicle seat armrest or console lid, or other suitable vehicle part. The cushion device is typically secured via a looped component (or sleeve) which is secured to the bottom portion of the outer covering.

In a preferred embodiment, the outer covering comprises a securing component to securely close the opening at either end. The securing component can comprise a zipper, hook and loop fasteners, snaps, or a clasp, etc., or any other suitable fastening means as is known in the art. However, a securing component is not needed and the outer covering can function without a securing component, allowing the opening to be left open. The securing component acts to securely retain the cushion insert within the outer covering.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A illustrates a front perspective view of the cushion insert of the cushion device in accordance with the disclosed architecture.

FIG. 1B illustrates a front perspective view of the cushion device in accordance with the disclosed architecture.

FIG. 2 illustrates a side perspective view of the cushion device in accordance with the disclosed architecture.

FIG. 3 illustrates a side perspective view of the cushion device in accordance with the disclosed architecture.

FIG. 4 illustrates a perspective view of the bottom portion of the cushion device in accordance with the disclosed architecture.

FIG. 5 illustrates a perspective view of the cushion device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses an improved armrest that can provide drivers and passengers of a motorized vehicle, airplane, train, or boat with a convenient and comfortable place to rest their arm. The present invention resembles a sleeve-like device that can be slipped onto the top surface or lid of the center console or armrest. The armrest device can be padded and covered with variously designed fabrics. Along with providing a padded resting area for users, the armrest device can also protect the top surface or lid of the console or armrest and prevent it from fading or getting worn out.

The cushion device comprises an outer covering and a cushion insert. The outer covering comprises an interior hollow cavity with an opening at either end. The cushion insert is disposed interior to the outer covering within the hollow cavity. The cushion device is then removably secured to a vehicle seat armrest or console lid, or other suitable vehicle part. The cushion device is typically secured via a looped component (or sleeve) which is secured to the bottom portion of the outer covering, or the looped component can completely surround the outer covering. The outer covering can further comprise a securing component to securely close the opening at either end, and to securely retain the cushion insert within the outer covering.

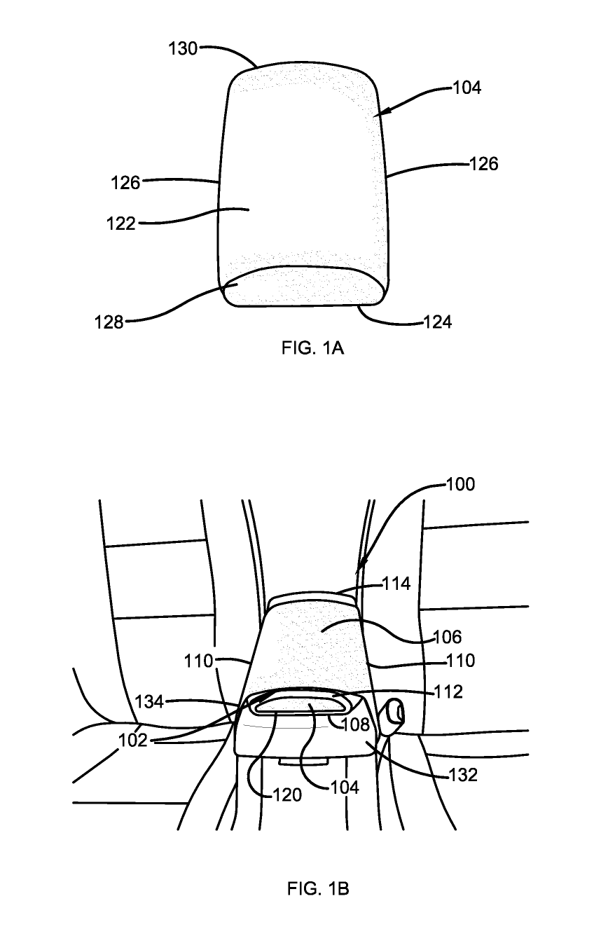

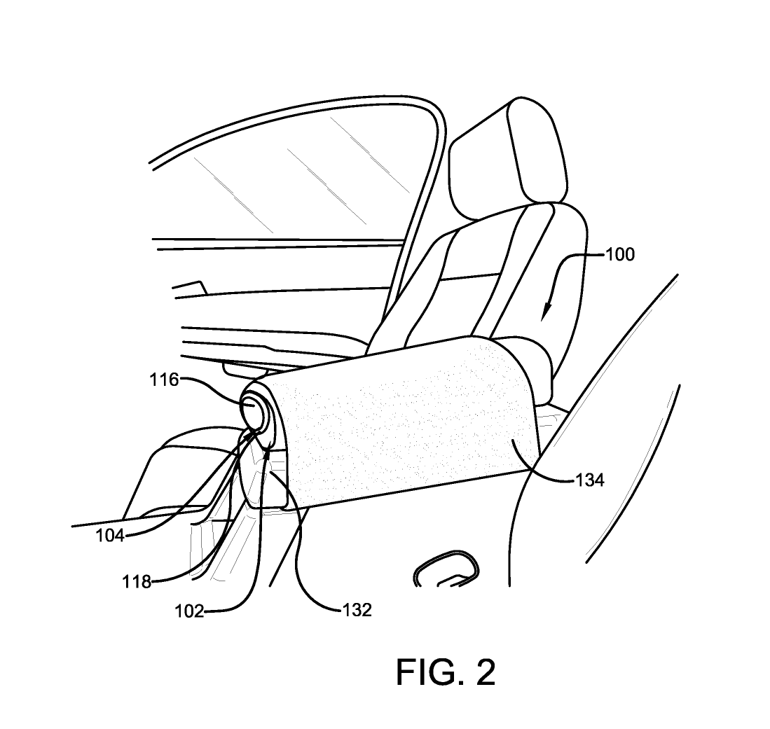

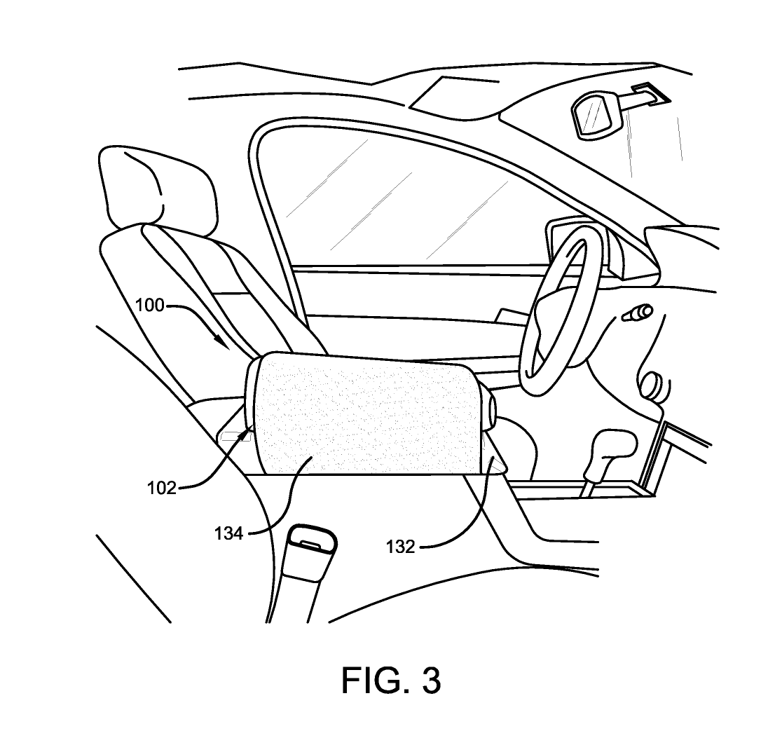

Referring initially to the drawings, FIGS. 1A, 1B, 2 and 3 illustrate the cushion device 100 used to cover and protect the center console and/or armrest in a vehicle. The cushion device 100 comprises an outer covering 102 and a cushion insert 104. The outer covering 102 comprises a top portion 106 and a bottom portion 108 and opposing sides 110. Typically, the outer covering 102 is a rectangular prism in shape, however any other suitable shape can be used as is known in the art without affecting the overall concept of the invention.

The outer covering 102 would generally be constructed of cotton, polyester, vinyl sheeting, or leather, etc., though any other suitable material may be used to manufacture the outer covering 102 as is known in the art without affecting the overall concept of the invention. The outer covering 102 can also comprise a variety of colors and designs to suit user preference. The outer covering 102 is approximately between 6 and 18 inches long as measured from a first end 112 to the second end 114, approximately between 4 and 18 inches wide as measured from opposing sides 110, and approximately between 2 and 3 inches thick as measured from top portion 106 to bottom portion 108, when the outer covering 102 is fully extended.

The outer covering 102 further comprises an interior hollow cavity 116 with an opening 118 at either or both of the first end 112 or the second end 114. The outer covering 102 also comprises a securing component 120 to securely close the opening 118 of the first end 112 and/or second end 114. The securing component 120 can comprise a zipper, hook and loop fasteners, snaps, or a clasp, etc., or any other suitable fastening means as is known in the art, without affecting the overall concept of the invention. However, a securing component 120 is not needed and the outer covering 102 can function without a securing component 120, allowing the opening 118 to be left open.

The cushion device 100 further comprises a cushion insert 104. The cushion insert 104 is disposed interior to the outer covering 102 within the hollow cavity 116. The securing component 120 acts to securely retain the cushion insert 104 within the outer covering 102. The cushion insert 104 comprises a top portion 122 and a bottom portion 124 and opposing sides 126. Typically, the cushion insert 104 is a rectangular prism in shape, however any other suitable shape can be used as is known in the art without affecting the overall concept of the invention, as long as it generally matches the shape of the outer covering 102. Furthermore, the cushion insert 104 can be replaced if lost or if the cushion insert 104 loses its shape over time.

The cushion insert 104 would generally be constructed of foam, such as memory foam, expanded polypropylene (EPP) foam, or ethylvinyl acetate (EVA) foam, etc., though any other suitable material may be used to manufacture the cushion insert 104 as is known in the art without affecting the overall concept of the invention. The cushion insert 104 is approximately between 6 and 18 inches long as measured from a first end 128 to the second end 130, approximately between 4 and 18 inches wide as measured from opposing sides 126, and approximately between 2 and 3 inches thick as measured from top portion 122 to bottom portion 124.

Typically, the cushion insert 104 is disposed interior to the outer covering 102, within the hollow cavity 116. The cushion device 100 is then removably secured to a vehicle seat armrest or console lid 132, or other suitable vehicle component, or even an airplane, train, or boat armrest, etc. The cushion device 100 is typically secured via a looped component (or sleeve) 134 which is secured to the bottom portion 108 of the outer covering 102, however, the cushion device 100 can be secured to the vehicle seat armrest or console lid 132 via any other securing means as is known in the art, such as hook and loop fasteners, temporary adhesives, magnets, etc. Further, the looped component (or sleeve) 134 is secured to the bottom portion 108 of the outer covering 102 via stitching, gluing, molding, etc., or any other suitable securing means as is known in the art without affecting the overall concept of the invention. Additionally, the looped component 134 is a sleeve-like piece of material that allows the cushion device 100 to slide onto the vehicle seat armrest or console lid 132. The looped component (or sleeve) 134 is typically constructed of the same materials as the outer covering 102, such as cotton, polyester, vinyl sheeting, or leather, etc., or even an elastic type material so that it fits snugly over the armrest or console lid, though any other suitable material may be used to manufacture the looped component 134 as is known in the art.

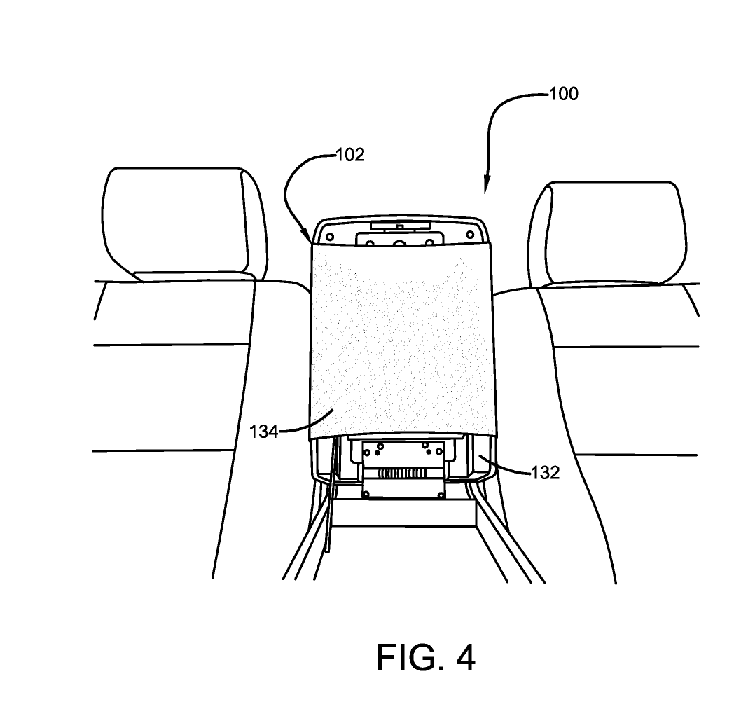

FIG. 4 illustrates the bottom portion of the cushion device 100, wherein a looped component 134 is attached. Specifically, the cushion device 100 is removably secured to a vehicle seat armrest or console lid 132, or other suitable vehicle component via a looped component (or sleeve) 134. The looped component (or sleeve) 134 is secured to the bottom portion of the outer covering 102 via stitching, gluing, molding, etc., or any other suitable securing means as is known in the art without affecting the overall concept of the invention. Additionally, the looped component 134 is a sleeve-like piece of material that allows the cushion device 100 to slide onto the vehicle seat armrest or console lid 132, much like a pillowcase. The looped component (or sleeve) 134 is typically constructed of the same materials as the outer covering 102, such as cotton, polyester, vinyl sheeting, or leather, etc., though any other suitable material may be used to manufacture the looped component 134 as is known in the art. However, the cushion device 100 does not have to be secured to the vehicle seat armrest or console lid 132 via the looped component 134, and can be secured to the vehicle seat armrest or console lid 132 via any other securing means as is known in the art, such as hook and loop fasteners, temporary adhesives, magnets, etc.

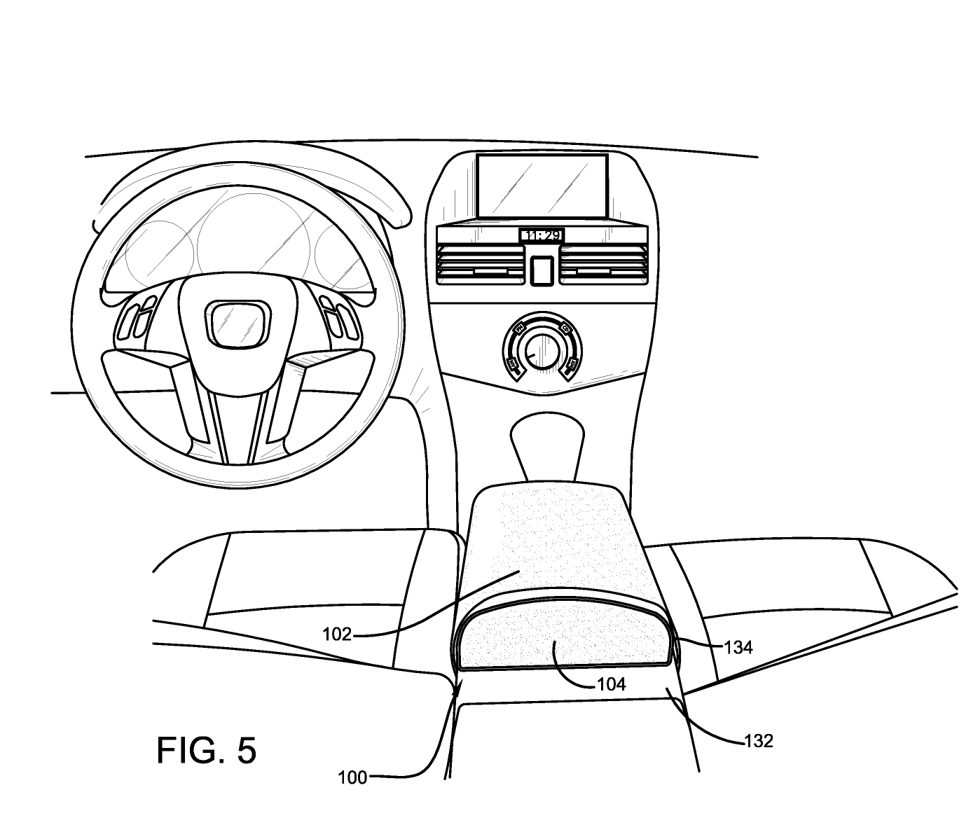

FIG. 5 illustrates the cushion device 100 in use. In operation, a user (not shown) would choose the color and/or specific design for the outer covering 102. The user would then insert the cushion insert 104 into the interior hollow cavity of the outer covering 102. If the outer covering comprises a securing component, then the user would close the outer covering 102 via the securing component. For example, the user would zip, snap, Velcro, or fasten the securing component, securing the cushion insert 104 inside the outer covering 102. If the outer covering 102 does not comprise a securing component, the cushion insert 104 is just slid into the cavity of the outer covering 102 and retained by friction.

Once the cushion insert 104 is inserted inside the outer covering 102 and secured, the cushion device 100 is then removably secured to a vehicle seat armrest, or console lid 132, or other vehicle component. The cushion device 100 is typically secured via a looped component (or sleeve) 134 which is secured to the bottom portion of the outer covering 102, however the cushion device 100 can be secured to the vehicle seat armrest or console lid 132 via any other securing means as is known in the art. If a looped component 134 is used, the looped component 134 is a sleeve-like piece of material that allows the cushion device 100 to slide onto the vehicle seat armrest or console lid 132, much like a pillowcase. The looped component 134 (or sleeve-like device) is then slipped onto the top surface or lid of the center console 132 or vehicle seat armrest.

Once, the cushion device 100 is slid onto the vehicle seat armrest or console lid 132, the user and/or another passenger or driver can utilize the cushion device 100 for a convenient and comfortable place to rest their arm. Furthermore, along with providing a padded resting area for users, the armrest cushion device 100 can also protect the top surface or lid of the center console 132 or vehicle seat armrest and prevent it from fading or getting worn out.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cushion device for use with a vehicle seat armrest, comprising:
an outer covering comprising an interior hollow cavity with an opening at a first end;
a cushion insert being disposed interior to the outer covering, within the hollow cavity; and
wherein the cushion device is removably secured to a vehicle seat armrest or console lid.

2. The cushion device of claim 1, wherein cushion insert comprises memory foam.

3. The cushion device of claim 2, wherein the memory foam is between one and three inches thick.

4. The cushion device of claim 1, wherein the outer covering comprises at least one of cotton or polyester.

5. The cushion device of claim 4, wherein the outer covering comprises a securing component to close the opening at the first end and to securely retain the cushion insert within the outer covering.

6. The cushion device of claim 5, wherein the securing component comprises at least one of a zipper, hook and loop fasteners, snaps, or a clasp.

7. The cushion device of claim 6, wherein the outer covering comprises a second opening at a second end.

8. The cushion device of claim 1, wherein the cushion device is removably secured to a vehicle seat armrest via a looped component secured to the bottom portion of the outer covering.

9. A cushion device for use with a vehicle seat armrest, comprising:
an outer covering comprising an interior hollow cavity with an opening at a first end;
a cushion insert being disposed interior to the outer covering, within the hollow cavity; and
wherein the cushion device is removably secured to a vehicle seat armrest via a looped component secured to the bottom portion of the outer covering.

10. The cushion device of claim 9, wherein the outer covering comprises at least one of cotton or polyester.

11. The cushion device of claim 10, wherein the outer covering comprises a securing component to close the opening at the first end and to securely retain the cushion insert within the outer covering.

12. The cushion device of claim 11, wherein the securing component comprises at least one of a zipper, hook and loop fasteners, snaps, or a clasp.

13. The cushion device of claim 9, wherein cushion insert comprises memory foam.

14. The cushion device of claim 13, wherein the memory foam is between one and three inches thick.

15. The cushion device of claim 9, wherein the looped component is a sleeve-like piece of material that allows the cushion device to slide onto the vehicle seat armrest.

16. A cushion device for use with a vehicle seat armrest, comprising:
an outer covering comprising an interior hollow cavity with an opening at a first end;
a memory foam insert being disposed interior to the outer covering, within the hollow cavity; and
wherein the cushion device is removably secured to a vehicle seat armrest via a looped component secured to the bottom portion of the outer covering.

17. The cushion device of claim 16, wherein the outer covering comprises at least one of cotton or polyester.

18. The cushion device of claim 17, wherein the outer covering comprises a securing component to close the opening at the first end and to securely retain the memory foam insert within the outer covering.

19. The cushion device of claim 18, wherein the securing component comprises at least one of a zipper, hook and loop fasteners, snaps, or a clasp.

20. The cushion device of claim 16, wherein the memory foam insert is between one and three inches thick.
